(19) United States
(12) Patent Application Publication
(10) Pub. No.: US 2015/0125669 A1
(43) Pub. Date: May 7, 2015

(54) Pre-Fabricated Marking System And A Method For Producing Said System

(71) Applicant: VISUTEC AS, Haugesund (NO)

(72) Inventors: Stein Dietrichson, Fredrikstad (NO); Gunnar Strøm, Dilling (NO)

(73) Assignee: VISUTEC AS, Haugesund (NO)

(21) Appl. No.: 14/395,898

(22) PCT Filed: Apr. 22, 2013
(86) PCT No.: PCT/EP2013/058277

§ 371 Date: Oct. 21, 2014

Related U.S. Application Data
(60) Provisional application No. 61/657,457, filed on Jun. 8, 2012.

(30) Foreign Application Priority Data
Apr. 23, 2012 (NO) 20120469

(51) Int. Cl. E01F 9/04; B05D 5/06; G09F 7/16

(52) U.S. Cl. CPC E01F 9/042; G09F 7/165; B05D 5/06
USPC 428/195.1; 427/157; 427/557

(57) ABSTRACT

This invention concerns a pre-fabricated marking system and a method for producing such a marking system, comprising the steps of a) producing a base layer (4) made of a first meltable composition whereby said first meltable composition comprises a material selected from the group consisting of resin, polymer, filler, softener and plasticizer, b) cooling the so produced base layer (4), c) applicating at least one, wholly or partly covering layer (5) onto the base layer (4) of one or more different second meltable composition(s) whereby said second meltable composition comprises a material selected from the group consisting of resin, polymer, plasticizer and preferably one or more pigments (2,3), and d) solidifying at least the base layer (4).

### FIELD OF THE INVENTION

After-glowing pigments are used in marking systems, e.g. for escape ways and marking of safety equipment, such that those are more visible in the dark, or to be independent of electricity supply in case of a power failure and a potentially dangerous situation. Such after-glowing marking systems are charged by daylight or light emitted by lamps. Such marking systems can be printed symbols or labels, tape systems or coating systems. All of those have limited abrasion resistance.

### BACKGROUND OF THE INVENTION

In the field of road markings, light-reflecting fillers are used, however, those are not after-glowing.

Such marking systems are also used to mark parking areas, private and public areas such as playing grounds and school grounds. Such markings can be done using symbols and colours, but in this case the substrate or surface has to be prepared by taping with masking tapes upon which the symbol or colours are applied in various steps upon which the symbol has to dry or harden (cure). One problem associated with this procedure is that the application of an abrasion resistant epoxy coating (as an example) will be time-demanding as the coated areas require drying or curing time, therefore these areas cannot be used during the curing time.

For a white base layer and subsequent application of two layers water-based epoxy coating, the area needs to be closed for 24 hours to allow sufficient hardening. It is usual that solvent-based pigments are used for pigmented marking systems which results in solvent emission into the environment during drying/curing.

WO 0024969 discloses a surface coating designed for use on roads, parking areas and the like. The coating consists of elastic particles and light-reflecting glass beads or ceramics. Photo-luminescent pigments can be used in the coating, as well as particles to achieve higher friction. The coating is applied onto standard road marking before said standard road marking is hardened. It is essentially the light diffraction and reflection properties of glass which shall be used in order to increase the visibility of road marking.

GB 2324325A relates to a road marking material with a base layer which is applied onto the road, and where thereafter an upper transparent layer with reflective materials and photo-luminescent materials is applied. An example for the base layer is a conventional road paint made of thermoplastic which is heated, and thereafter the upper layer is applied.

US 20030123930 A1 describes a magnetic pavement marking material and a system to use such a material. A row of marking materials is applied to the pavement from a pre-fabricated tape and is fastened to the underground by using adhesives and pressure.

US 2010055374A1 by Robert Greer et al. discloses retroreflective pre-formed thermoplastic pavement markings. These consist of typically two layers characterized by different melting temperatures. Especially good bonding to the pavement due to lower melting temperature of the layer facing the pavement is reported as advantage.

Retroflective markings are very different from the after-glowing markings disclosed in this invention. Retroreflective markings contain large amounts of non-transparent mineral fillers which render the polymer formulation highly viscous. The materials used in this invention are significantly less viscous and easy flowing, thus requiring very different production technology, among which cooling sequences to control and maintain shape, thickness and integrity of the products. Surprisingly, this invention has succeeded in using easily flowing materials containing no mineral fillers, but containing transparent pigments instead, in a novel pre-fabrication technology to produce articles and markings described in detail below.

The following disclosures give a general view of the state-of-the-art and are relevant for markings, but not for the special preparation techniques disclosed below. WO 2011/096822 describes photo-luminescent decal devices consisting of many layers. CN 2004 101 5574 2004 0309 describes the preparation of active white zirconium based pigments. WO 99/20701 describes useful binders for markings, including polymers, tackifiers, modified polyethylenes and inorganic fillers. DE 100 44 300 A1 describes highly retro-reflective markings containing inorganic fillers such as TiO2 for roads.

An after-glowing pigment which can be used in marking systems is strontium aluminate. This pigment is very expensive but has a long after-glowing time and is therefore well suited for applications according to the invention. After-glowing traffic safety systems will improve traffic safety where street light is absent. Abrasion-resistant markings of e.g. escape ways will increase the safety in areas with intensive traffic. Abrasion-resistance of marking systems is the more important the more intensive or heavy the traffic is.

General problems encountered in the field are thus drying and curing time, price, and duration of the after-glow.

### SUMMARY OF THE INVENTION

In one aspect, the invention describes a method for producing a pre-fabricated marking system comprising a) producing a base layer made of a first meltable composition, whereby said meltable composition comprises a material selected from the group consisting of resin, polymer, filler, softener and plasticizer, b) cooling the so produced base layer, c) applicating at least one, wholly or partly covering layer onto the base layer of one or more different second meltable compositions, whereby said second meltable composition comprises a material selected from the group consisting of resin, polymer, plasticizer and preferably one or more pigments, and d) the solidifying at least the base layer.

In one embodiment of the pre-fabricated marking system according to the invention, at least one of the first and second meltable compositions will comprise after-glowing pigments.

One advantage of the invention is that the consumption of expensive pigments can be reduced in the case of the partial coatings, i.e. only partly covering coatings. At the same time, corrugated after-glowing marking systems can be realized.

In one embodiment of the invention, the pre-fabricated marking system can be a palate or a tape which can be wound to or from a roll. This tape can be used for partial or completely covering marking.

In another aspect, the invention consists of a pre-fabricated marking system comprising an base layer of a first meltable composition, whereby said meltable composition comprises a material selected from the group consisting of resin, polymer, filler, softener and plasticizer, where further onto the base layer one or more, partly or wholly covering layers, of a different second meltable compositions, whereby said second meltable composition comprises a material selected from the group consisting of resin, polymer, plasticizer and preferably one or more pigments.

In one embodiment of the invention, at least one of the first and second meltable compositions will contain an after-glowing component or photoluminescent component.

It is a significant advantage that this marking system is pre-formed before it is applied at the point of use as waste can be reduced significantly compared with marking systems which are applied from an at least partly liquid batch onto the surface.

### SHORT DESCRIPTION OF THE DRAWINGS

The invention will be described more closely below with reference to the attached drawings, on which:

FIG. 1 is a perspective view of a marking system in relation to an embodiment of the invention which can be either a limited plate or a roll of desired length,

FIG. 2 shows a top view in relation to the invention and shows a plate where the covering layer is partly covering,

FIG. 3 shows a cut through a plate covered with a point-shaped area as in FIG. 2 on a surface, and

FIG. 4 illustrates an embodiment of the invention where the plate is shaped as a ribbon band or band which can be rolled up or rolled down from a roll.

### DETAILED DESCRIPTION OF PREFERRED EMBODIMENTS

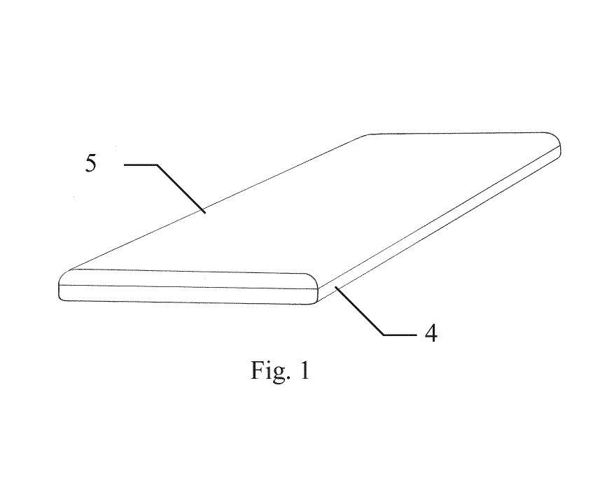

FIG. 1 is a perspective view of a marking system in relation to an embodiment of the invention showing a base layer 4 with a covering layer 5 on the top. The marking system is intended to be placed on a substrate or surface not shown.

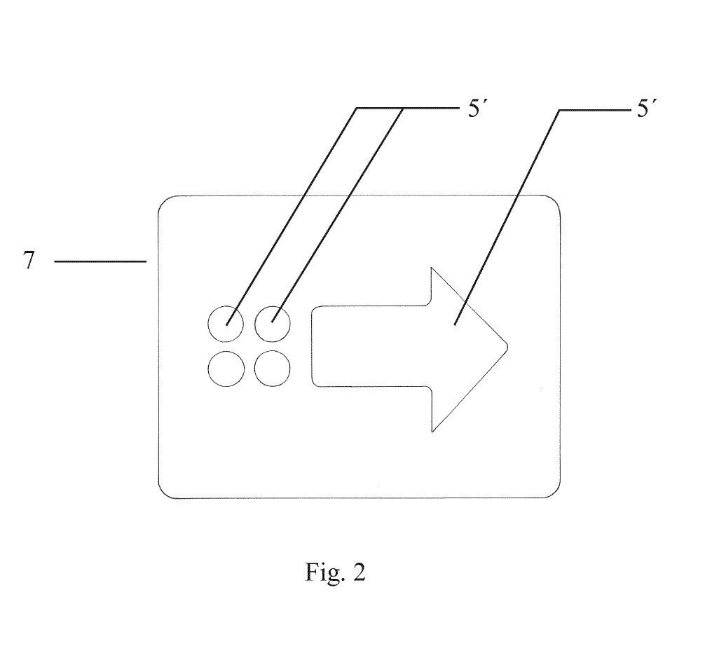

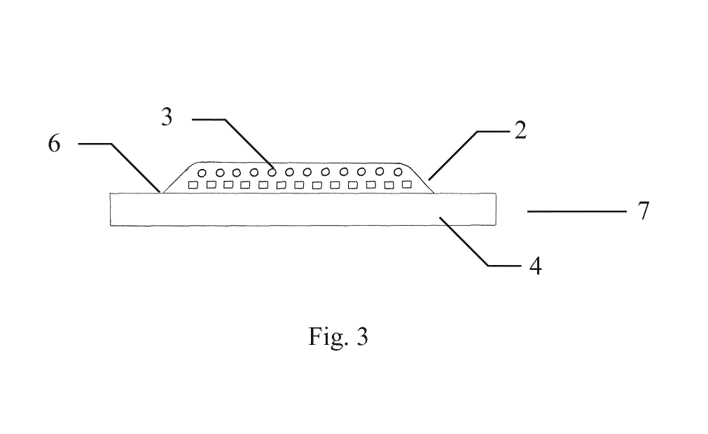

As can be inferred from FIG. 2, in a preferred embodiment, the covering layer 5 is formed as a partly covering layer 5′ forming point-shaped areas. These can be made of different meltable compositions which may contain different pigments 2,3. See FIG. 3. The point-shaped areas can have very different shapes and may form symbols.

FIG. 3 shows a cut through a plate 7 covered with a point-shaped area as in FIG. 2 on a surface 6.

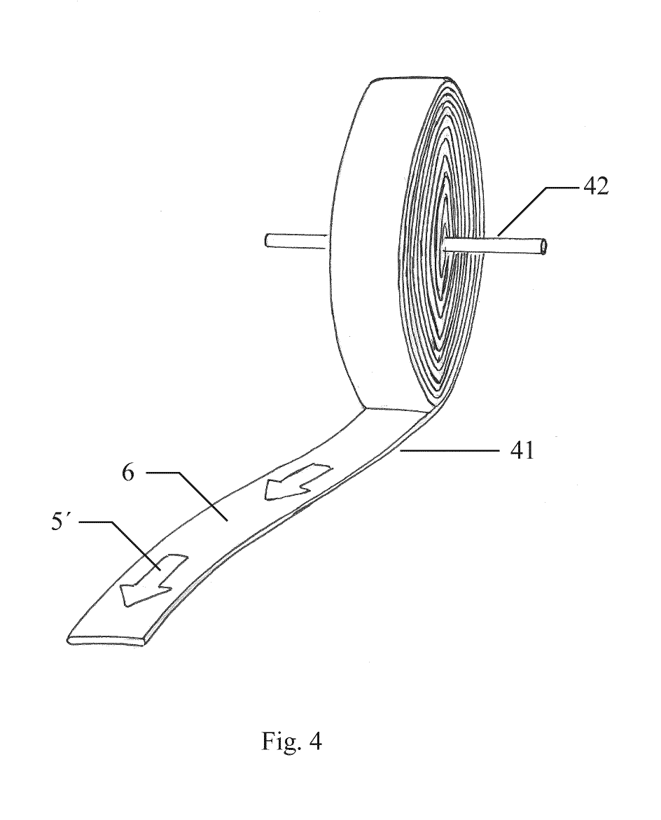

FIG. 4 illustrates an embodiment of the invention where the plate 7 is shaped as a ribbon band or band which can be rolled up or rolled down from a roll 42. In this illustration, the wholly or partly covering layer 5 is partly covering, however, in different embodiments these may be wholly covering or be shaped e.g. as symbols.

One advantage of the invention is that the pre-fabricated marking system is produced with at least one layer where the first meltable composition of the base layer 4 can be adapted to the substrate or surface onto which the system is applied, and with at least one, wholly or partly covering layer on top of the base layer of one or more different second meltable compositions. The base layer should e.g. be easy meltable and result in good adhesion to a substrate or surface. It may be pigmented but is preferably not pigmented or white. The second meltable composition is formed such that abrasion resistance, dirt repellency and such desired properties results. It can also be shaped in such a manner that patterns of different pigments are formed in the wholly or partly covering layer(s) 5 are formed.

Further, the invention comprises in one embodiment that, at an application site, the pre-fabricated marking system is placed on the targeted substrate by placing the marking system on said substrate using a mobile coating device according to known art, heat the marking system using a mobile heat source, such that at least the base layer 4 partly melts or softens and thereby brought into firm contact to the substrate. In one embodiment, at least one of the first and second meltable compositions will contain an after-glowing component or photoluminescent component 3.

In some meltable compositions, rubber such as thermoplastic elastomer can be a component.

Advantages of the invention are that consumption of expensive pigments is reduced in the case of coatings comprising several layers and point-wise coatings, i.e. partly covering layers. At the same time, corrugated marking systems can be realized, preferably after-glowing corrugated marking systems.

Pigmentation is preferably realized using a hotmelt system.

In one embodiment of the invention, as shown in FIG. 4, the reflecting plate can be a tape 41 which is rolled off a roll 42 and is further used for wholly or partly covering marking. It is a significant advantage that this marking system is pre-formed before it is applied at the point of use as waste can be reduced significantly compared with marking systems which are applied from a at least partly liquid batch of low, medium or high viscosity onto the surface. In practice, where such liquid marking compositions are transported to the point of use, losses are very usual, e.g. as waste, undesired spill and remaining material which cannot be used and may polymerize or solidify in the transport container. Usually, such mixtures for both base layer and wholly or partly covering layers are quickly hardening.

The base layer can be prepared in different mixing ratios and can therefore be adapted to give good adhesion to most substrates and also to different climatic or geographical conditions. A special advantage of the methods described in this invention is that the methods are time-saving in the application in relation to prior art, and marked areas can be opened for traffic within a shorter time than compared to prior and known art.

In a different aspect, the invention is a marking system, preferably an after-glowing pre-fabricated marking system, comprising a base layer 4 of a first meltable composition, whereby said first meltable composition comprises a material selected from the group consisting of resin, polymer, filler, softener and plasticizer, where further, onto said base layer 4 is applied one or more, wholly or partly covering layers 5 made of one or more different second meltable compositions comprising a material selected from the group consisting of resin, polymer, plasticizer and preferably one or more pigments 2,3, and where at least one of the second meltable compositions contains an after-glowing component, where the base layer 4 can be softened or plasticized or melted and is designed such that it can be laid out using a known mobile coating device and a mobile heat source, such that at least the base layer 4 adheres to the substrate yielding a marking of very high abrasion resistance. In one embodiment, the base layer 4 can be 0.5-3 mm thick.

In one embodiment of the invention, strontium aluminate is used as after-glowing or photo-luminescent pigment or component 3. Strontium aluminate can, under the right conditions, show up to 100 hours of after-glowing time. This is an advantage for use of markings over longer periods of time, e.g. for illumination of escape ways during prolonged power outages, marking where electricity is not available but where daylight or other temporary lighting is available.

In a preferred embodiment, as strontium aluminate is very expensive as after-glowing chemical, it is of great advantage to use the method according to the invention, namely to provide symbols or markings in a partly covering layer, e.g. in the shape of symbol made of point-shaped markings, as opposed to wholly covering layers containing the after-glowing component. The optional other pigmented layers can also be constructed using point-shaped markings or symbols.

By point-shaped markings or symbols are meant markings or symbols with limited area compared to the area of the base layer.

In one embodiment of the invention where photo-luminescent pigments, preferably strontium aluminate, are used, the base layer 4 is preferably produced as white layer.

In one embodiment, between 30-70% by weight photoluminescent pigment 3 is used.

By using strontium aluminate, a light-resistant marking is obtained.

Another advantage of using strontium aluminate in pre-fabricated marking systems according to the invention is that these markings are after-glowing which obviates the need for adding glass or glass beads for obtaining reflectivity.

Therefore, markings can be visible even if a light source is absent, provided that the marking has been exposed to a light source for some time during the preceding 100 hours.

In one embodiment of the method, one or more of the wholly or partly covering layers will solidify during or after processing in the pre-fabrication machinery, i.e. prior to application at the mounting site. In some embodiments, said layers will harden or cure. It is an advantage that such partial solidification or hardening occurs as it is desired that the markings adhere well to the substrate at the mounting site, and that they preserve the shape of the symbols during and after mounting. The products shall be drying and hardening with time, and shall be heat-resistant such that they withstand the heat treatment during the mounting process at the mounting site which shall be marked.

The substrate at the mounting site can be any solid material including asphalt, asphalt or bitumen-like materials, concrete, stone, metal, wood or epoxy. The method and the system according to the invention will in different embodiments be suitable for marking of roads, tunnels, parking areas, school yards, playing grounds, and escape routes, e.g. in factories, oil platforms, ships and buildings where abrasion resistance is an important issue. Where markings are applied in areas exposed to wear from vehicles, the markings shall withstand different strains dependent on geographical and demographic conditions. In the Nordic countries, markings shall typically withstand impact of studded tyres. In Africa, the demands for resistance against higher temperature and strong sun light are more pronounced.

In one embodiment of the invention, the heat source which is used for melting of the base layer 4 can be a gas flame, IR heating lamp, or an electrical heater, and suitable temperatures for heating will be in the range 100-250 degree Celsius (° C.). The base layer 4 will soften and finally melt and will adhere to the substrate and thereafter (upon cooling) solidify and result in good adhesion.

In different embodiments of the invention, the one or more covering layers will be in the shape of symbols or pictograms. Those can be pigmented using different pigments in the different wholly or partly covering layers such that a range of different symbols can be realized. Examples for those are markings for escape routes, direction arrows, markings for parking areas and markings of educational character for school yards. It is essential that that the partly covering layers has the form of point-shaped areas when they contain the expensive strontium aluminate such that total costs can be held at a low level.

In one embodiment, the pre-fabricated marking system can be a Braille marking (for visually impaired people) as the partly covering material can be prepared as a corrugated plate.

In one embodiment, the base layer 4 can be prepared using min. 16% by weight binder of which 10% by weight resin and min. 2% by weight plasticizer, said percentages relating to the complete base layer. This results in good adhesion to the substrate 6. The said resin can be of the type called rosin or C5, and the “ring and ball test” will show 100 degree Celsius. A tall oil based resin can also be used. Rubber, either natural or synthetic rubber, can be used in some meltable compositions. The plasticizer can be an oil or a traditional wax as used in the field of road marking. Those have somewhat negative properties as far as adhesion to the substrate is concerned, but better properties regarding discolouration.

Combinations of different plasticizers are conceivable. Special waxes (e.g. polar axes such as maleic anhydride grafted waxes) can be used for better adhesion.

In one embodiment of the invention, the photo-luminescent pigment 3 is dispersed in an extrudable binder. This is advantageous for the extrusion of the wholly or partly covering layer.

In one embodiment of the invention, dirt repellent components such as Teflon (™) or fluor-containing components are used. It is important that such marking systems with or without after-glowing components are kept clean for visibility, especially in the case of escape routes, and this without the need for maintenance.

In one embodiment of the invention, the base layer 4 is prepared as a plate of limited dimensions, see FIG. 2, i.e. having a desired width and thickness. A further coating is then applied on this single plate. A plurality of plates can be stacked for transport, and at the mounting site the plates are placed one after the another from the stack using the procedure described above, i.e. by smelting the base layer to afford adhesion to the substrate. In a different embodiment, the base layer 4 and therefore the whole pre-fabricated marking system is prepared in the pre-fabrication machinery as a tape or band which is rolled off from a roll as a band 41 of desired width and thickness. At the mounting site, a continuous marking or marking of desired length can be mounted using the melting procedure described above.

In one embodiment of the invention, fillers such as glass, preferably glass beads of diameters between 0.05 mm (millimetre) and 1.5 mm diameter, are used. Glass beads, especially those between 0.3 and 0.8 mm in diameter, provide light reflection but are as such not after-glowing.

In one embodiment of the invention, the wholly or partly covering layer(s) can be extruded onto the base layer. This will give a total layer thickness of 1-5 mm, and will be of advantage in corrugated marking systems where the extra effect of generation of sound or vibration is desired, e.g. if a vehicle happens to drive over such a corrugated marking.

In one embodiment, pigments 2,3 may be pre-grinded to certain size distributions, such as peaking at 50 micrometer, or peaking at 100 micrometer, or between 50 and 500 micrometer.

In one embodiment, pigments 2,3 are surface-treated before they are blended into the formulation. The surface may be of hydrophobic, oleophobic or hydrophilic character. Surface treatment may be done with silanes or other chemicals according to known art. One purpose of surface treatment is to provide dirt repellancy. Another purpose can be better mechanical strength, better adhesion within the plastic matrix.

In one embodiment, nano-silica such as Elkem silica 999 or silica from Degussa, Cabot or other suppliers is added to the formulation at concentrations between 0.1 and 5% by weight. One purpose of this is to increase the viscosity of the formulation. Another purpose is to reduce the surface roughness. Yet another purpose is to control the depth to which glass beads will sink in the liquid formulation. It is desired to keep reflective glass beads partly above the plastic layer to provide maximum reflectivity.

In one embodiment, a road marking may comprise a standard marking combined with a line or structured line containing after-glowing pigments whereby said line is 1-5 cm wide.

In a different embodiment, the wholly or partly covering layers are applied onto the base layer using automatic brush spray technique. This will result in thinner layers which is advantageous in terms of raw material usage. In some embodiments, the thickness of the layer will be between 0.5 and 1 mm. This will be advantageous if no effect from a potentially corrugated surface is desired or needed.

A different aspect of the invention is the use of a pre-fabricated marking system, preferably an after-glowing pre-fabricated marking system, in relation to the practical application, as described above, for the marking of floors, walls, roofs, safety equipment such as fire extinguishers, roads, escape routes, airports, landing strips for rescue helicopters, tunnels, mines, storage facilities, factories, parking areas, school yards and the like. An advantage of the marking systems according to the invention is therefore that it can be applied even if no light source is available, provided the marking system has been charged with light before. In many geographical areas, it may be very difficult to supply electricity for lighting to areas which shall be marked. Alternatively, e.g. at harbour areas or in mines and tunnels, there may be risk for electrical shortcuts and the like if temporarily electrical light is used to illuminate the mounting site.

It is considered as part of the invention to combine different features in different embodiments as described above. At the same time, no embodiments and features shall be seen as mutually excluding.

1-26. (canceled)

27. A method for producing a pre-fabricated marking system, comprising the steps of:
a) producing a base layer made of a first meltable composition whereby said first meltable composition comprises a material selected from the group consisting of resin, polymer, filler, softener and plasticizer,
b) cooling the so produced base layer,
c) applicating at least one, wholly or partly covering layer onto the base layer of one or more different second meltable composition(s) whereby said second meltable composition comprises a material selected from the group consisting of resin, polymer, plasticizer and preferably one or more pigments, and
d) solidifying at least the base layer,
further wherein at least one of the following conditions is met:
said at least one the wholly or partly covering layers also solidifies,
said at least one first and second meltable compositions is pigmented using an after-glowing component or photoluminescent component,
said at least one of the covering layer is shaped like symbols, pictograms or other markings,
pigments and the after-glowing component are resistant to high temperature and optionally also to UV light,
the after-glowing component or photoluminescent component is strontium aluminate,
the base layer is made using at least 16% by weight binder of which about 10% by weight resin and at least 2% by weight plasticizer, said percentages relating to the complete base layer.

28. The method according to claim 27, wherein said marking system is produced as a plate, and wherein the plate is rolled up like a band of desired width and thickness to form a roll.

29. The method according to claim 27, wherein said wholly or partly covering layer(s) are extruded onto the base layer.

30. The method according to claim 27, wherein said wholly or partly covering layer(s) is applied onto the base layer using spray machinery.

31. The method according to claim 27, wherein, at an area of application of the pre-fabricated marking system, the marking system is placed on the desired substrate, and wherein, with the help of a mobile heat source, wherein the said mobile heat source is a gas burner, an infrared lamp or an electrical heater, and said at least the base layer is melted or softened such that the marking system is fastened to the substrate using a mobile placement device.

32. The method according to claim 27, wherein the substrate at the mounting site and where the marking system is placed, is selected from the group consisting of asphalt, bitumen-like products, wood, metal, concrete, stone, paper, cardboard-based materials, and thermosetting plastic such as epoxy or polyurethane.

33. The method according to claim 27, wherein said roll is rolled off at said mounting site.

34. A pre-fabricated marking system comprising:
a base layer of a first meltable composition whereby said first meltable composition comprises a material selected from the group consisting of resin, polymer, filler, softener and plasticizer, and onto which base layer is applied at least one, wholly or partly covering layer of one or more different second meltable composition whereby said second meltable composition comprises a material selected from the group consisting of resin, polymer, plasticizer and preferably one or more pigments,
further wherein at least one of the following conditions is met:
said at least one wholly or partly covering layer is shaped as symbol, pictogram or other marking,
said at least one first and second meltable composition contains an after-glowing component or photoluminescent component,
pigments and the after-glowing component are resistant to high temperature and optionally also to UV light,
the after-glowing or photoluminescent component is strontium aluminate, the base layer contains at least 16% by weight binder of which 10% by weight resin and at least 2% by weight plasticizer, said percentages relating to the complete base layer,
said marking system contains a component which repels dirt, e.g. containing very hydrophobic particles such as fluoropolymers including Teflon (™),
the marking system is produced as a plate and where preferably the plate is rolled up like a band of desired width and thickness to form a roll on or after the pre-fabrication machinery, and where said roll is rolled off at the mounting site, the thickness of the wholly or partly covering layer is in the range 0.5-5 mm.
the thickness of the base layer is in the range 0.5-3 mm, or
the base layer is plasticizable or meltable and designed such that it can be arranged using a mobile placement device and using a mobile heat source such that at least the base layer is firmly connected to a substrate, and wherein the marking system is forming an abrasion-resistant marking on said substrate.

35. Use of a pre-fabricated marking system according to claim 27 as marking on walls, floors, roofs, roads, escape routes, storage halls, factory areas, tunnels, airports, railway stations, safety and rescue equipment, parking areas, school yards and the like.
